(19) United States
(12) Patent Application Publication
(10) Pub. No.: US 2011/0043430 A1
(43) Pub. Date: Feb. 24, 2011

(54) MANUFACTURE OF A SMART CARD

(76) Inventors: Oded Bashan, Rosh Pina (IL); Guy Shafran, Rosh Pina (IL); Tom Rahav, Rosh Pina (IL)

Correspondence Address: QUARLES & BRADY LLP, 411 E. WISCONSIN AVENUE, SUITE 2040, MILWAUKEE, WI, 53202-4497, US

(21) Appl. No.: 12/863,714

(22) PCT Filed: Jan. 25, 2009
(86) PCT No.: PCT/IL2009/000095

§ 371 Date: Oct. 29, 2010

Related U.S. Application Data
(60) Provisional application No. 60/062,164, filed on Oct. 16, 1997.

(51) Int. Cl. H01Q 7/00; H01P 11/00

(52) U.S. Cl. 343/866; 29/600; 29/729

(57) ABSTRACT

Methods for manufacturing a smart card inlay. In a first embodiment, the method includes initially connecting a first end (106) of a wire antenna (108) to a chip module (104) mounted in an aperture (102) on a substrate (100), thereafter fixing the wire antenna (108) onto the substrate (100) and thereafter connecting a second end (112) of the wire antenna (108) to the chip module (104). In a second embodiment, the method includes providing a wire antenna having a first end (200) and a second end (202), wherein the first end (200) and the second end (202) are connected to a chip module (206) and do not extend past the chip module (206) and fixing the wire antenna (204) to a substrate (208).

### REFERENCE TO RELATED APPLICATIONS

Reference is hereby made to U.S. Provisional Patent Application Ser. No. 61/062,164, entitled MANUFACTURE OF A SMART CARD INLAY, filed Jan. 23, 2008, the disclosure of which is hereby incorporated by reference and priority of which is hereby claimed pursuant to 37 CFR 1.78(a) (4) and (5)(i).

### FIELD OF THE INVENTION

The present invention relates to the manufacture of wireless transponder units such as those employed in smart cards having contactless functionality.

### BACKGROUND OF THE INVENTION

The following patent documents are believed to represent the current state of the art:

U.S. Pat. Nos. 7,278,580; 7,271,039; 7,269,021; 7,243,840; 7,240,847 and 7,204,427.

### SUMMARY OF THE INVENTION

The present invention seeks to provide improved methods of manufacturing wireless transponder units useful as smart card inlays.

There is thus provided in accordance with a preferred embodiment of the present invention a method for manufacturing a smart card inlay including initially connecting a first end of a wire antenna to a chip module mounted in an aperture on a substrate, thereafter fixing the wire antenna onto a substrate and thereafter connecting a second end of the wire antenna to the chip module.

There is also provided in accordance with another preferred embodiment of the present invention a method for manufacturing a smart card inlay including providing a wire antenna having a first end and a second end, wherein the first end and the second end are connected to a chip module and do not extend past the chip module and fixing the wire antenna to a substrate.

There is further provided in accordance with still another preferred embodiment of the present invention a method for manufacturing a smart card inlay including fixing a wire antenna, having a first end and a second end, to a substrate, aside from the first end and the second end and thereafter relocating the first end and the second end of the wire antenna to locations suitable for attachment to a chip module and thereafter connecting the first end and the second end to the chip module.

There is also provided in accordance with another preferred embodiment of the present invention a method for manufacturing a smart card inlay including connecting a first end and a second end of a wire antenna to a chip module, fixing the wire antenna to a substrate and thereafter relocating the chip module to a chip module location on the substrate.

Preferably, the connecting a first end and a second end of a wire antenna to a chip module includes connecting the first end prior to the fixing the wire antenna to a substrate and connecting the second end subsequent to the fixing the wire antenna to a substrate.

There is further provided in accordance with still another preferred embodiment of the present invention a method for manufacturing a smart card inlay including attaching first and second ends of a wire antenna to a first substrate, fixing the wire antenna, aside from the first and second ends thereof, to a second substrate, thereafter relocating the first substrate relative to the second substrate such that the first and second ends of the wire antenna are at locations suitable for connection to a chip module on the second substrate, thereafter connecting the first end and the second end to the chip module and thereafter removing the first substrate.

In accordance with a preferred embodiment of the present invention the attaching first and second ends of a wire antenna to a first substrate includes connecting the first end prior to the fixing the wire antenna and connecting the second end subsequent to the fixing the wire antenna.

There is even further provided in accordance with yet another preferred embodiment of the present invention a method for manufacturing a smart card inlay including initially holding a first end of a wire antenna with a holding device, thereafter fixing the wire antenna onto a substrate, thereafter holding a second end of the wire antenna with the holding device and thereafter connecting the first end and the second end to a chip module.

There is yet further provided in accordance with another preferred embodiment of the present invention a method for manufacturing a smart card inlay including initially holding a first end of a wire antenna with a first holding device, thereafter fixing the wire antenna onto a substrate, thereafter holding a second end of the wire antenna with a second holding device and thereafter connecting the first end and the second end to a chip module.

Preferably, the method also comprises attaching the chip module to the substrate. In accordance with a preferred embodiment of the present invention the method includes any suitable combination of two or more of the steps recited above.

In accordance with a preferred embodiment of the present invention the fixing the wire antenna includes removably mounting the substrate onto a movable surface and moving the substrate relative to a fixed wire embedding device for fixing the wire antenna to the substrate.

There is even further provided in accordance with yet another preferred embodiment of the present invention a method for manufacturing a smart card inlay including removably mounting a substrate onto a movable surface and moving the substrate relative to a fixed wire embedding device for fixing the wire antenna to the substrate.

There is also provided in accordance with another preferred embodiment of the present invention a smart card inlay including a substrate and a wire antenna fixed to the substrate and having first and second ends thereof connected to a chip module mounted in an aperture formed in the substrate, wherein the first and second ends do not extend from the antenna past the chip module.

There is further provided in accordance with still another preferred embodiment of the present invention a system for manufacturing a smart card inlay including an electrical connecting tool operative to initially connect a first end of a wire antenna to a chip module mounted in an aperture on a substrate, a wire antenna placement tool operative to thereafter fix the wire antenna onto a substrate and an electrical connecting tool operative to thereafter connect a second end of the wire antenna to the chip module.

There is even further provided in accordance with yet another preferred embodiment of the present invention a system for manufacturing a smart card inlay including a wire antenna producing and connecting tool operative to provide a wire antenna having a first end and a second end arranged such that the first end and the second end are connected to a chip module and do not extend past the chip module and a wire antenna mounting tool operative to fix the wire antenna to a substrate.

There is yet further provided in accordance with another preferred embodiment of the present invention a system for manufacturing a smart card inlay including a wire antenna placement tool operative to fix a wire antenna, having a first end and a second end, to a substrate, aside from the first end and the second end, a wire relocation tool operative to thereafter relocate the first end and the second end of the wire antenna to locations suitable for attachment to a chip module and an electrical connecting tool operative to thereafter connect the first end and the second end to the chip module.

There is also provided in accordance with still another preferred embodiment of the present invention a system for manufacturing a smart card inlay including an electrical connecting tool operative to connect a first end and a second end of a wire antenna to a chip module, a wire antenna placement tool operative to fix the wire antenna to a substrate and a chip module relocation tool operative to thereafter relocate the chip module to a chip module location on the substrate.

In accordance with a preferred embodiment of the present invention the electrical connecting tool is operative to connect the first end prior to the wire antenna placement tool fixing the wire antenna to a substrate and connect the second end subsequent to the wire antenna placement tool the fixing the wire antenna to a substrate.

There is further provided in accordance with still another preferred embodiment of the present invention a system for manufacturing a smart card inlay including a wire attaching tool operative to attach first and second ends of a wire antenna to a first substrate, a wire antenna placement tool operative to fix the wire antenna, aside from the first and second ends thereof, to a second substrate, a substrate relocating tool operative to thereafter relocate the first substrate relative to the second substrate such that the first and second ends of the wire antenna are at locations suitable for connection to a chip module on the second substrate, an electrical connecting tool operative to thereafter connect the first end and the second end to the chip module and a substrate removing tool operative to thereafter remove the first substrate.

Preferably, the wire attaching tool is operative to connect the first end prior to the wire antenna placement tool fixing the wire antenna to a substrate and connect the second end subsequent to the wire antenna placement tool the fixing the wire antenna to a substrate.

There is still further provided in accordance with another preferred embodiment of the present invention a system for manufacturing a smart card inlay including a holding device operative to hold a first end of a wire antenna, a wire antenna placement tool operative to thereafter fix the wire antenna onto a substrate, a wire placement tool operative thereafter to place a second end of the wire antenna into the holding device and an electrical connecting tool operative to thereafter connect the first end and the second end to a chip module.

There is also provided in accordance with yet another preferred embodiment of the present invention a system for manufacturing a smart card inlay including a first holding device operative to initially hold a first end of a wire antenna, a wire antenna placement tool operative to thereafter fix the wire antenna onto a substrate; a second holding device operative to thereafter hold a second end of the wire antenna and an electrical connecting tool operative to thereafter connect the first end and the second end to a chip module.

Preferably, the system for manufacturing a smart card inlay also includes a chip module attaching tool operative to attach the chip module to the substrate.

In accordance with another preferred embodiment of the present invention the system for manufacturing a smart card inlay includes any suitable combination of two or more tools recited above. Additionally or alternatively, the wire antenna placement tool includes a fixed wire embedding device operative to fix the wire antenna to the substrate and a movable surface operative to move the substrate relative to the fixed wire embedding device.

There is further provided in accordance with still another preferred embodiment of the present invention a system for manufacturing a smart card inlay including a fixed wire embedding device operative to fix a wire antenna to a substrate and a movable surface operative to move the substrate relative to the fixed wire embedding device.

### BRIEF DESCRIPTION OF THE DRAWINGS

The present invention will be understood and appreciated more fully from the following detailed description, taken in conjunction with the drawings in which:

FIGS. 1A, 1B, 1C & 1D are simplified illustrations of four steps in a method for manufacture of a wireless transponder in accordance with a first embodiment of the present invention;

FIGS. 2A & 2B are simplified illustrations of a method for manufacture of a wireless transponder in accordance with a second embodiment of the present invention;

FIGS. 3A, 3B and 3C are together a simplified illustration of a method for manufacture of a wireless transponder in accordance with a third embodiment of the present invention;

FIGS. 4A and 4B are simplified illustrations of two steps in a method for manufacture of a wireless transponder in accordance with a fourth embodiment of the present invention;

FIGS. 5A and 5B are simplified illustrations of two steps in a general method for manufacture of a wireless transponder in accordance with a fifth embodiment of the present invention;

FIGS. 6A, 6B, 6C, 6D and 6E are simplified illustrations of one example of carrying out the general method of FIGS. 5A & 5B;

FIGS. 7A and 7B are simplified illustrations of two steps in a general method for manufacture of a wireless transponder in accordance with a sixth embodiment of the present invention;

FIGS. 8A, 8B, 8C, 8D, 8E, 8F, 8G and 8H are simplified illustrations of one example of carrying out the general method of FIGS. 7A & 7B;

FIGS. 9A and 9B are simplified illustrations of two steps in a method for manufacture of a wireless transponder in accordance with a seventh embodiment of the present invention; and

FIGS. 10A, 10B, 10C, 10D and 10E are simplified illustrations of one example of carrying out the general method of FIGS. 9A & 9B.

### DETAILED DESCRIPTION OF PREFERRED EMBODIMENTS

The description which follows includes several embodiments which may be employed singly or in any combination in the manufacture of a wireless transponder, such as that used in a smart card inlay or any other suitable device.

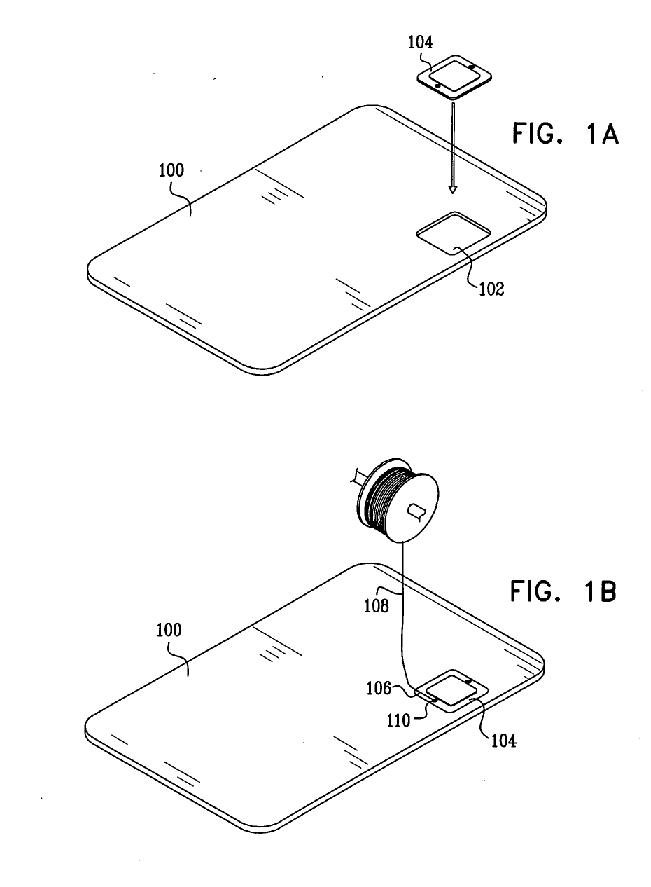

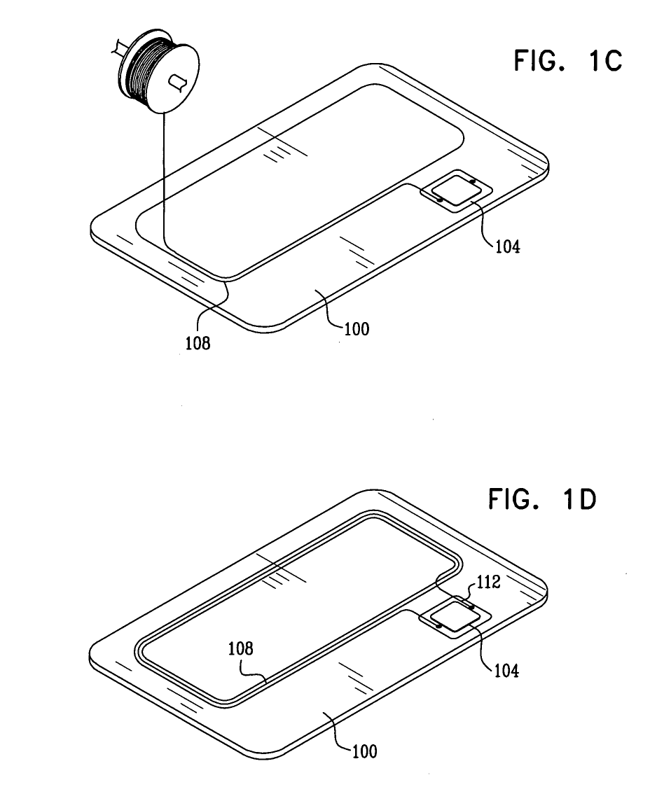

Reference is now made to FIGS. 1A, 1B, 1C & 1D, which are simplified illustrations of steps in a method for manufacture of a wireless transponder in accordance with a first embodiment of the present invention.

In the process for manufacturing a smart card inlay as shown in FIGS. 1A-1D, FIG. 1A shows an apertured card substrate 100, including an aperture 102, and a chip module 104 about to be mounted in the aperture 102. FIG. 1B shows chip module 104 mounted in the aperture 102 and also illustrates initially connecting a first end 106 of a wire antenna 108 to a terminal 110 of chip module 104. FIG. 1C illustrates the stage of thereafter fixing the wire antenna 108 onto substrate 100 and FIG. 1D illustrates the stage of thereafter connecting a second end 112 of the wire antenna 108 to the chip module 104.

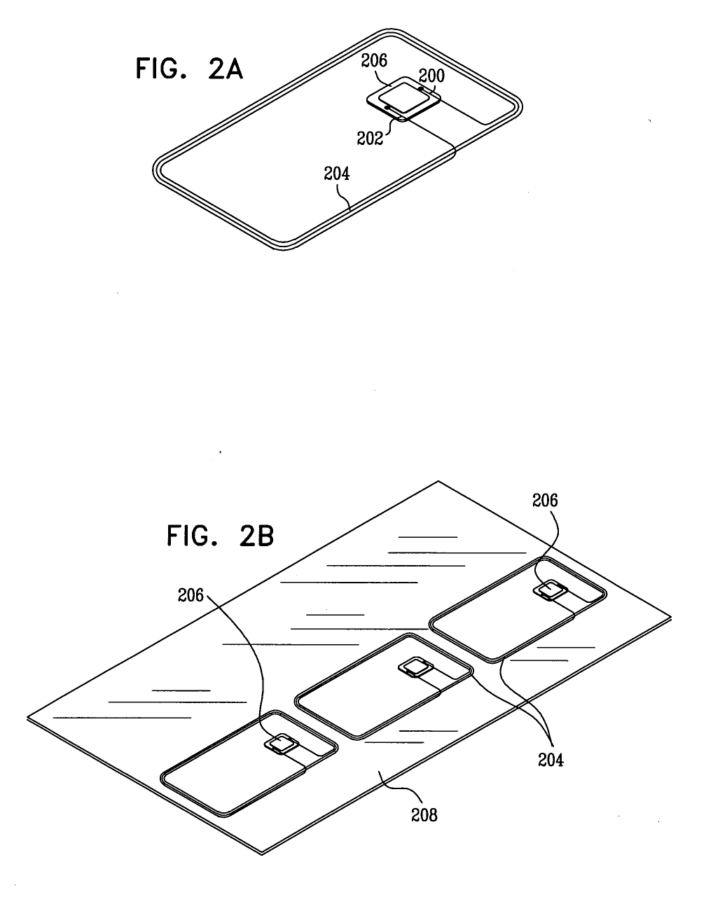

Reference is now made to FIGS. 2A & 2B, which are simplified illustrations of a method for manufacture of a wireless transponder in accordance with a second embodiment of the present invention.

In the process for manufacturing a smart card inlay as shown in FIGS. 2A and 2B, a first end 200 and a second end 202 of a wire antenna 204 are initially connected to a chip module 206, such that the first end 200 and the second end 204 do not extend past the chip module 206. The wire antenna 204 may be fixed to a substrate 208 before or after connection to the chip module 206. Substrate 208 preferably includes suitable apertures for the placement therein of chip modules 206 of wire antennas 204.

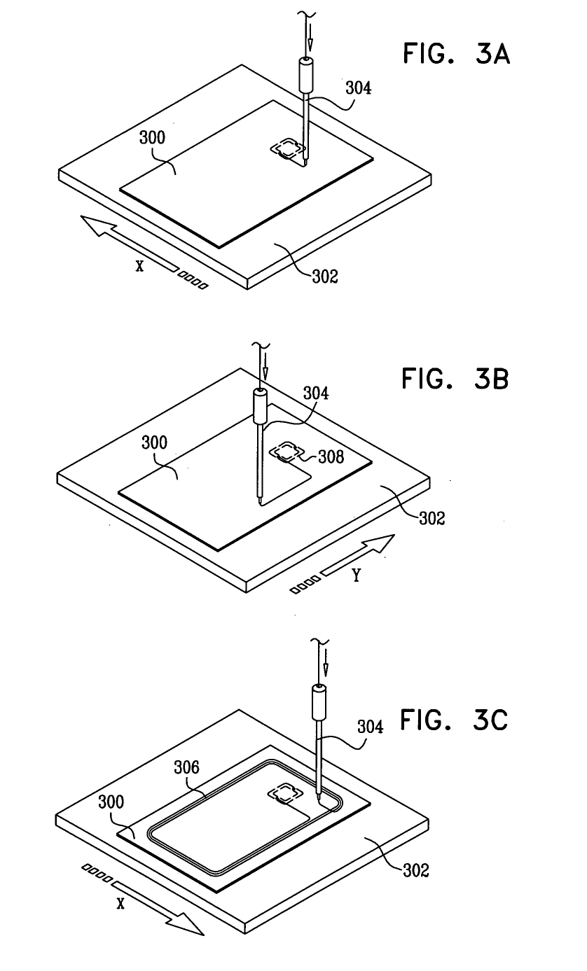

Reference is now made to FIGS. 3A, 3B and 3C, which together are a simplified illustration of a method for manufacture of a wireless transponder in accordance with a third embodiment of the present invention.

In the process for manufacturing a smart card inlay as shown in FIGS. 3A-3C, a substrate 300 is removably mounted onto a movable surface 302 and is moved relative to a fixed wire embedding device 304 for connecting first and second ends of a wire antenna 306 to a chip module 308 and fixing the wire antenna 306 to substrate 300.

It is appreciated that the technique of FIGS. 3A-3C may be employed in combination with any other suitable one of the embodiments of the present invention or suitable combinations thereof.

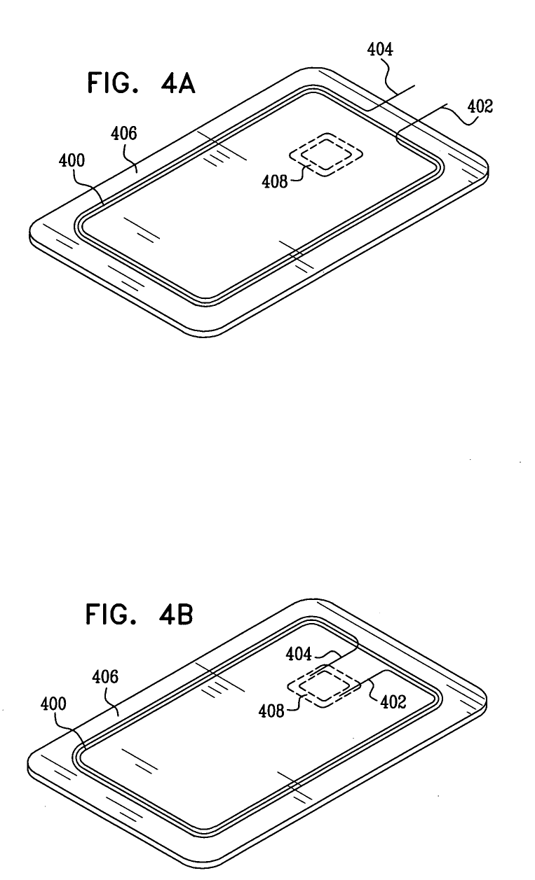

Reference is now made to FIGS. 4A and 4B, which are simplified illustrations of two steps in a method for manufacture of a wireless transponder in accordance with a fourth embodiment of the present invention.

In the process for manufacturing a smart card inlay as shown in FIGS. 4A & 4B, FIG. 4A shows attaching a wire antenna 400, having first and second ends 402 and 404 respectively, to a substrate 406 where the first and second ends 402 and 404 are not adjacent the chip module area 408 in the substrate 406 and FIG. 4B shows thereafter relocating the first and second ends 402 and 404 of wire antenna 400 to locations suitable for attachment to a chip module (not shown). It is appreciated that a chip module (not shown) is preferably placed in chip module area 408 for attachment to first and second ends 402 and 404 of wire antenna 400. The chip module may be placed in chip module area 408 either before or after first and second ends 402 and 404 of wire antenna 400 are relocated.

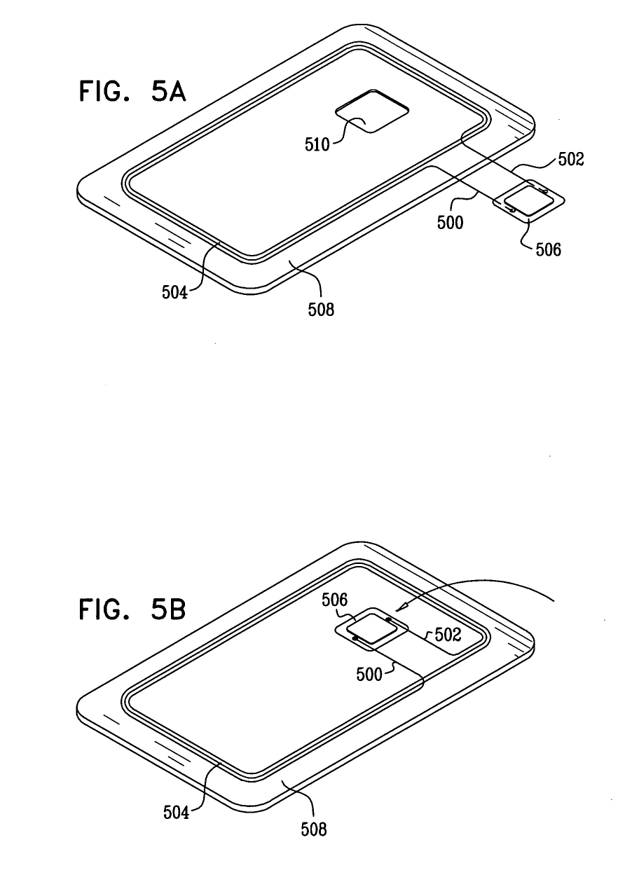

Reference is now made to FIGS. 5A and 5B, which are simplified illustrations of two steps in a general method for manufacture of a wireless transponder in accordance with a fifth embodiment of the present invention.

In the method for manufacturing a smart card inlay as shown in FIGS. 5A & 5B, FIG. 5A illustrates connecting first and second ends 500 and 502 of a wire antenna 504 to a chip module 506 and fixing the wire antenna 504 to a substrate 508 and FIG. 5B illustrates thereafter relocating the chip module 506 to a chip module location 510 on the substrate 508.

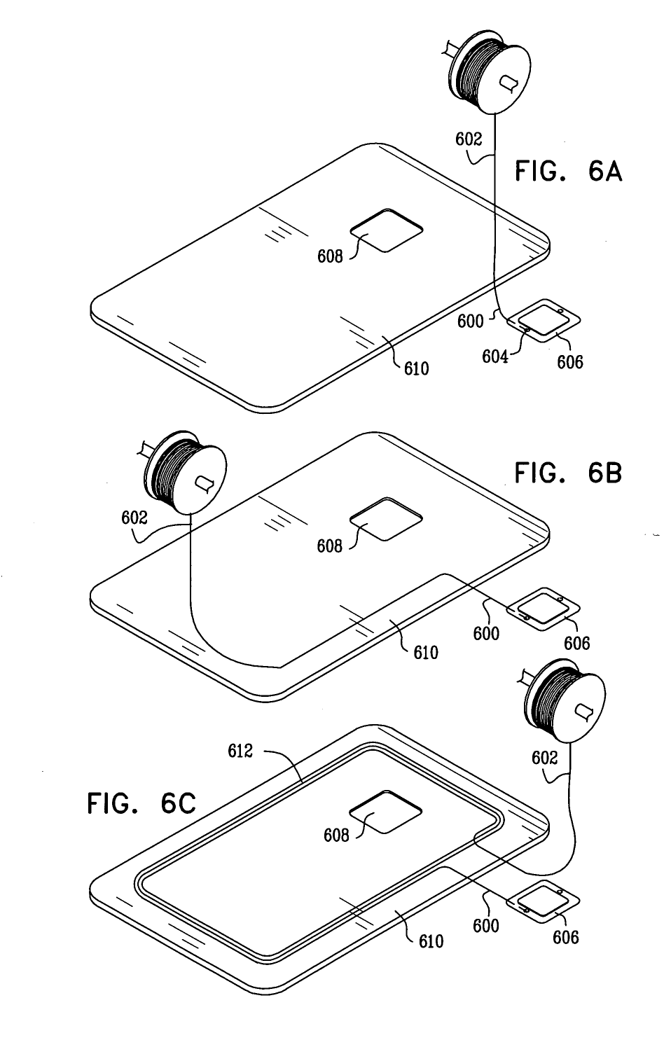

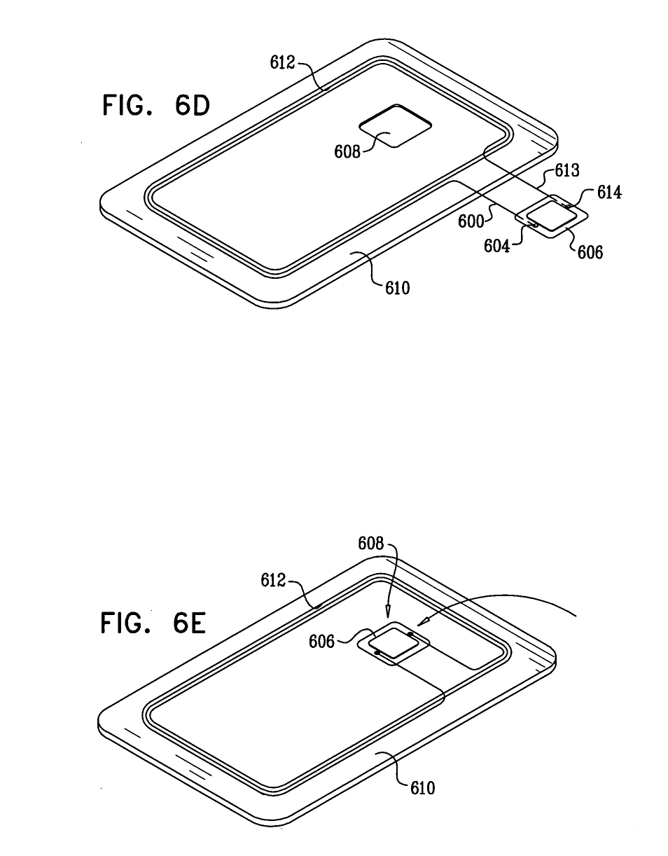

A manual manufacturing process suitable for carrying out the general method of FIGS. 5A and 5B is illustrated in FIGS. 6A, 6B, 6C, 6D & 6E, it being appreciated that a corresponding automated manufacturing process may readily be provided.

As seen in FIG. 6A, initially a first end 600 of wire 602 used for forming a wire antenna is attached to a first terminal 604 of a chip module 606, while the chip module 606 is located at a location other than the intended location 608 of the chip module 606, which may be an aperture formed on a substrate 610.

FIGS. 6B and 6C together show a wire antenna 612 being formed from wire 602 on substrate 610 and FIG. 6D shows attachment of a second end 613 of wire 602 to a second terminal 614 of chip module 606 subsequent to formation of the wire antenna 612 on substrate 610.

FIG. 6E shows subsequent relocation of the chip module 606 to the intended location 608 of the chip module 606 on substrate 610.

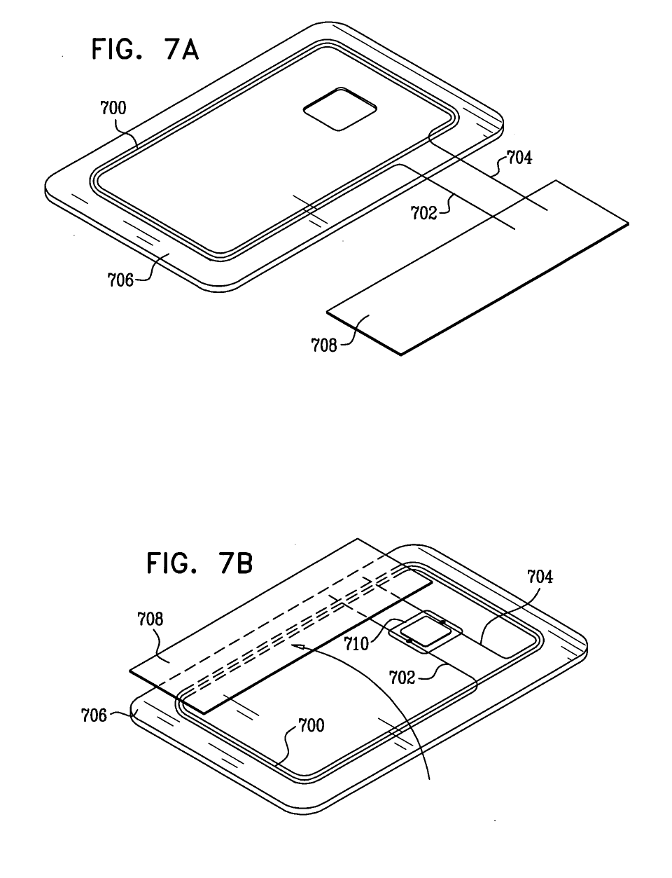

Reference is now made to FIGS. 7A and 7B, which are simplified illustrations of two stages in a method for manufacture of a wireless transponder in accordance with a sixth embodiment of the present invention.

In the process for manufacturing a smart card inlay as shown in FIGS. 7A & 7B, FIG. 7A illustrates attaching a wire antenna 700, aside from first end 702 and second end 704 thereof, respectively, to a main substrate 706 and attaching the first and second ends 702 and 704 of the wire antenna 700 to an auxiliary substrate 708. FIG. 7B illustrates a following step of thereafter relocating the auxiliary substrate 708 such that the first and second ends 702 and 704 of the wire antenna 700 are at locations which are suitable for attachment to a chip module 710 on the main substrate 706.

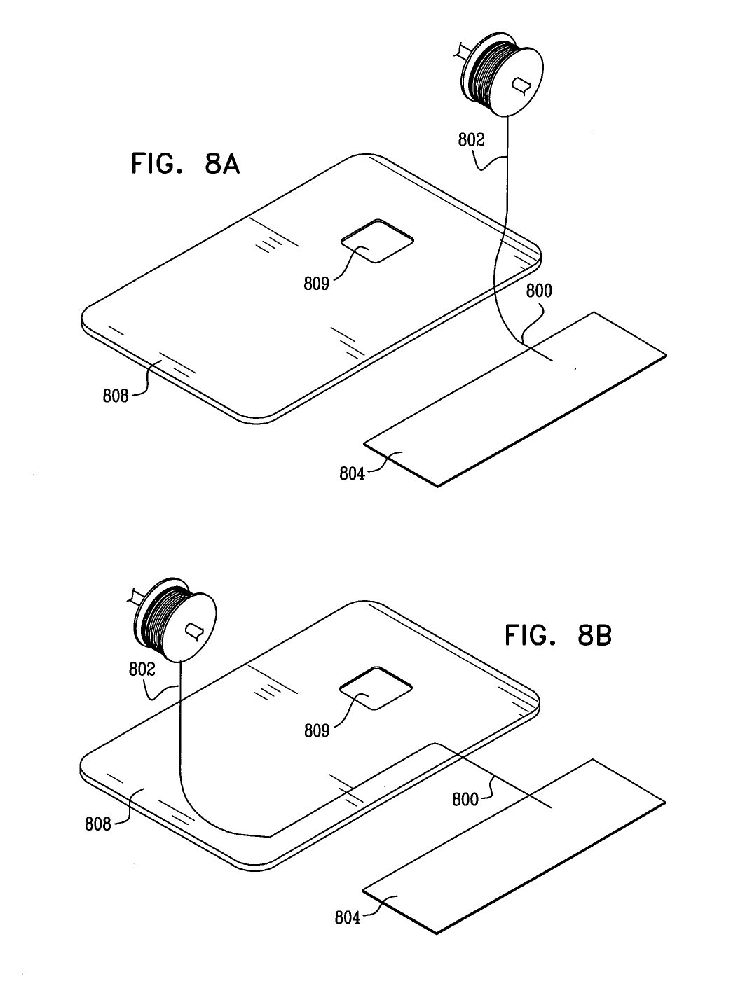

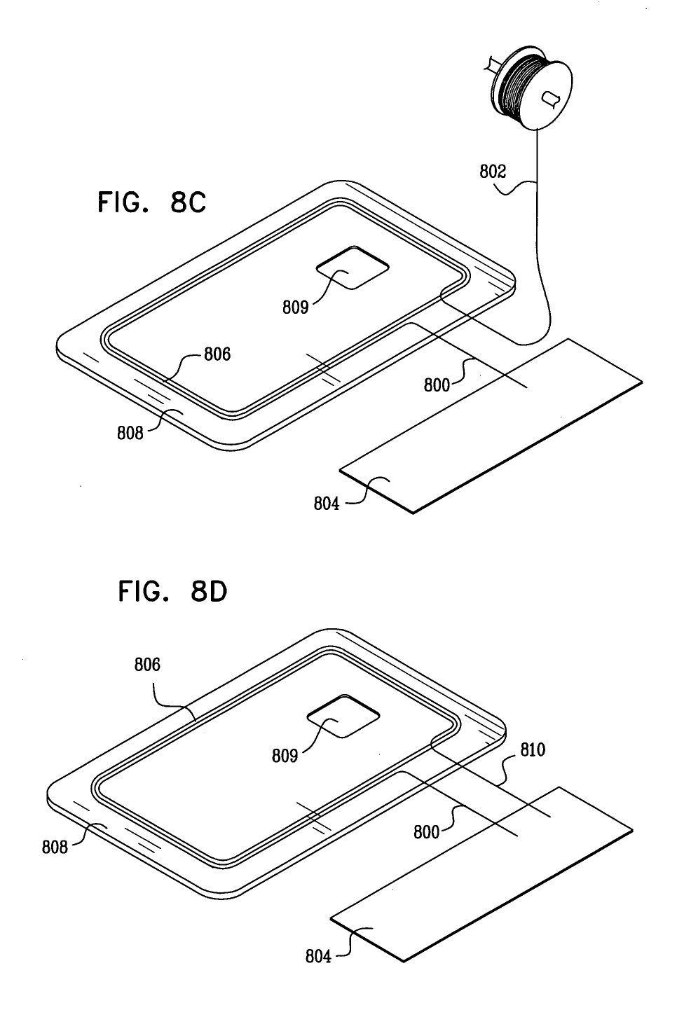

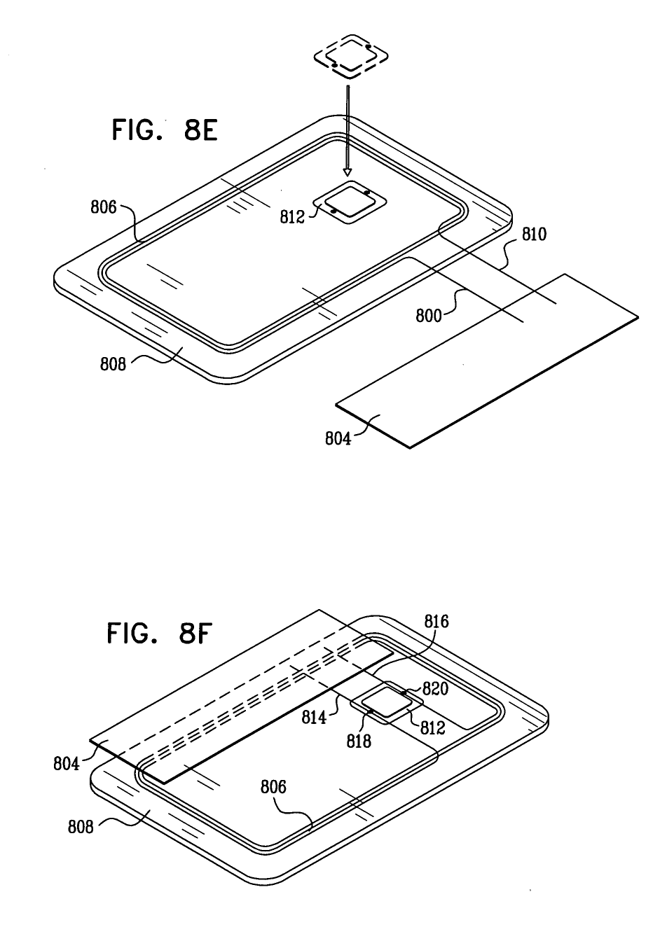

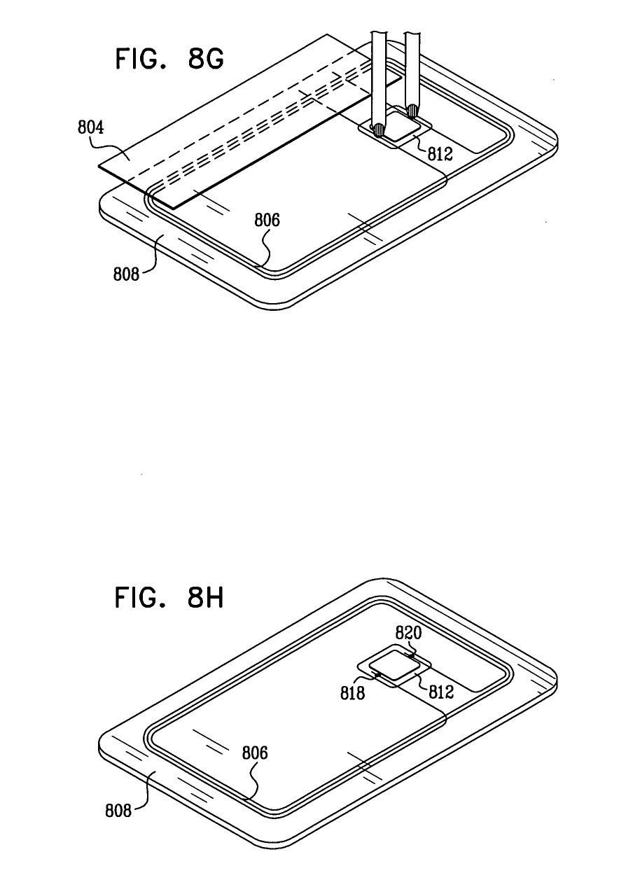

A manual manufacturing process suitable for carrying out the method of FIGS. 7A and 7B is illustrated in FIGS. 8A-8H, it being appreciated that a corresponding automated manufacturing process may readily be provided.

As seen in FIG. 8A, a first end 800 of antenna wire 802 is attached to an auxiliary substrate 804. FIGS. 8B & 8C together show a wire antenna 806 being formed from antenna wire 802 on a main substrate 808 in an otherwise conventional manner, such as by ultrasonic embedding. A chip module aperture 809 is formed in main substrate 808. FIG. 8D shows attachment of a second end 810 of the antenna wire 802, forming the wire antenna 806, to the auxiliary substrate 804.

FIG. 8E shows mounting of a chip module 812 in aperture 809 in the main substrate 808, following formation of the wire antenna 806. Alternatively, the chip module 812 may be placed in aperture 809 before forming wire antenna 806. In a further alternative embodiment, aperture 809 may be obviated and chip module 812 may be placed directly on the main substrate 808.

FIG. 8F shows repositioning of the auxiliary substrate 804 such that portions 814 and 816 of the antenna wire 802, which define first and second ends of the wire antenna 806, overlie corresponding terminals 818 and 820 of chip module 812 on the main substrate 808. FIG. 8G shows attachment of portions 814 and 816 to respective terminals 818 and 820 of chip module 812 and FIG. 8H shows a thus assembled smart card inlay after removal of the auxiliary substrate 804.

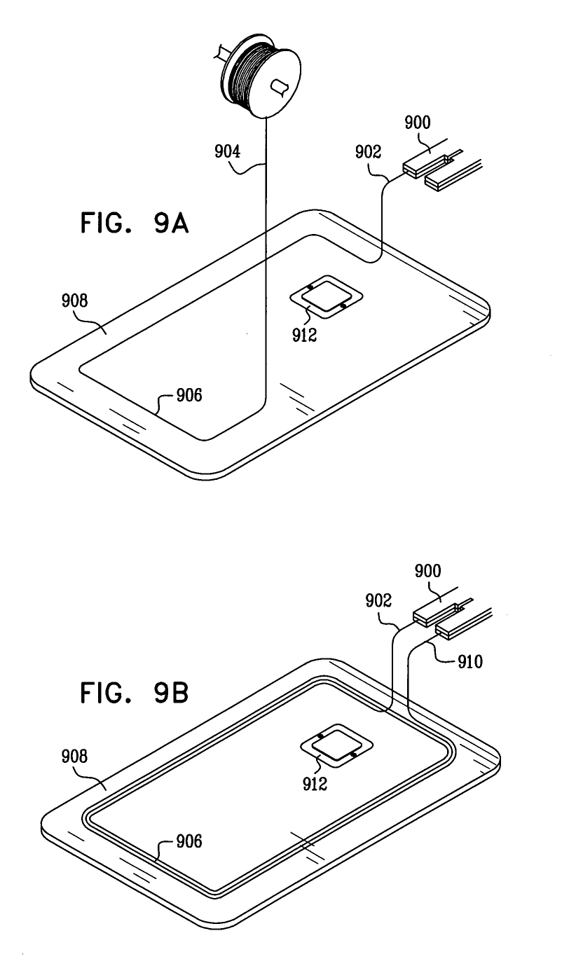

Reference is now made to FIGS. 9A and 9B, which are simplified illustrations of two steps in a method for manufacture of a wireless transponder in accordance with a seventh embodiment of the present invention.

In the process for manufacturing a smart card inlay as shown in FIGS. 9A & 9B, a holding device 900 initially holds a first end 902 of an antenna wire 904 while a wire antenna 906 is formed therefrom on a substrate 908 by conventional techniques. Following formation of the wire antenna 906 on the substrate 908, a second end 910 of antenna wire 904 is preferably held by the same or another holding device 900. Only thereafter are the ends 902 and 910 attached to corresponding terminals of a chip module 912, as the ends are held by holding device or devices 900 and not attached to substrate 908.

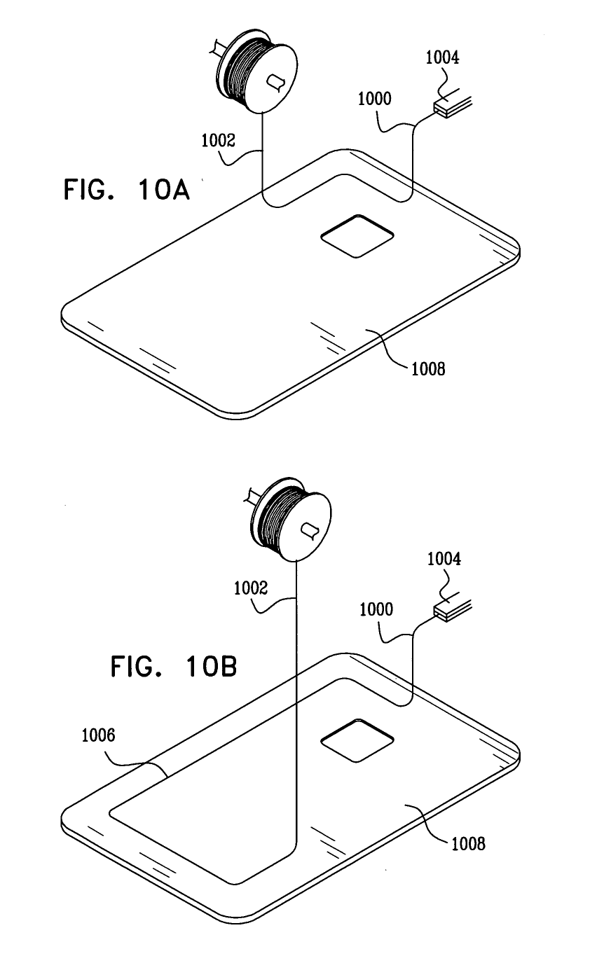

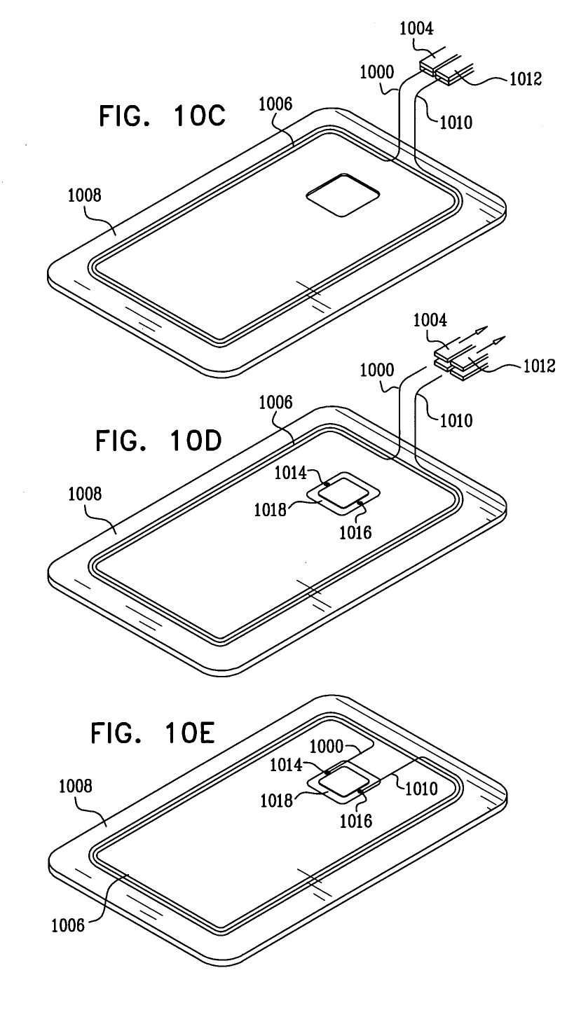

A manual manufacturing process suitable for carrying out the method of FIGS. 9A and 9B is illustrated in FIGS. 10A-10E, it being appreciated that a corresponding automated manufacturing process may readily be provided.

As seen in FIGS. 10A & 10B, a first end 1000 of antenna wire 1002 is held by a first gripper 1004 as a wire antenna 1006 is formed from antenna wire 1002 on a substrate 1008 in an otherwise conventional manner, such as by ultrasonic embedding. FIG. 10C shows a second end 1010 of the antenna wire 1002 being held by a second gripper 1012 following completion of the wire antenna 1006 and FIG. 10D shows ends 1000 and 1010 having been released from grippers 1004 and 1012 respectively following completion of the wire antenna. FIG. 10E shows attachment of ends 1000 and 1010 to respective terminals 1014 and 1016 of a chip module 1018 mounted on substrate 1008.

It is appreciated that second gripper 1012 may be obviated and first gripper 1004 may be configured to grip both first end 1000 and second end 1010 of antenna wire 1002, similar to holding device 900 of FIGS. 9A and 9B. It is also appreciated that a first and second gripper, such as grippers 1004 and 1012, may be used instead of holding device 900 of the embodiment shown in FIGS. 9A and 9B.

It will be appreciated by persons skilled in the art that the present invention is not limited by what has been particularly shown and described hereinabove. Rather, the present invention includes combinations and subcombinations of the various features described hereinabove as well as modifications and variations thereof which will occur to persons reading the foregoing and which are not in the prior art.

1. A method for manufacturing a smart card inlay comprising:
initially connecting a first end of a wire antenna to a chip module mounte.d in an aperture on a substrate;
thereafter fixing the wire antenna onto said substrate; and
thereafter connecting a second end of the wire antenna to the chip module.

2. A method for manufacturing a smart card inlay comprising:
providing a wire antenna having a first end and a second end, wherein said first end and said second end are connected to a chip module and do not extend past said chip module; and
fixing said wire antenna to a substrate.

3. A method for manufacturing a smart card inlay comprising:
fixing a wire antenna, having a first end and a second end, to a substrate, aside from said first end and said second end;
thereafter relocating said first end and said second end of said wire antenna to locations suitable for attachment to a chip module; and
thereafter connecting said first end and said second end to said chip module.

4. A method for manufacturing a smart card inlay comprising:
connecting a first end and a second end of a wire antenna to a chip module;
fixing said wire antenna to a substrate; and
thereafter relocating said chip module to a chip module location on said substrate.

5. A method for manufacturing a smart card inlay according to claim 4 and wherein said connecting a first end and a second end of a wire antenna to a chip module comprises:
connecting said first end prior to said fixing said wire antenna to a substrate; and
connecting said second end subsequent to said fixing said wire antenna to a substrate.

6. A method for manufacturing a smart card inlay comprising:
attaching first and second ends of a wire antenna to a first substrate;
fixing said wire antenna, aside from said first and second ends thereof, to a second substrate;
thereafter relocating said first substrate relative to said second substrate such that said first and second ends of said wire antenna are at locations suitable for connection to a chip module on said second substrate;
thereafter connecting said first end and said second end to said chip module; and
thereafter removing said first substrate.

7. A method for manufacturing a smart card inlay according to claim 6 and wherein said attaching first and second ends of a wire antenna to a first substrate comprises:
connecting said first end prior to said fixing said wire antenna; and
connecting said second end subsequent to said fixing said wire antenna.

8. A method for manufacturing a smart card inlay comprising:
initially holding a first end of a wire antenna with a holding device;
thereafter fixing said wire antenna onto a substrate;
thereafter holding a second end of said wire antenna with said holding device; and
thereafter connecting said first end and said second end to a chip module.

9. A method for manufacturing a smart card inlay comprising:
initially holding a first end of a wire antenna with a first holding device;
thereafter fixing said wire antenna onto a substrate;
thereafter holding a second end of said wire antenna with a second holding device; and
thereafter connecting said first end and said second end to a chip module.

10. A method for manufacturing a smart card inlay according to claim 8 and also comprising attaching said chip module to said substrate.

11. (canceled)

12. A method for manufacturing a smart card inlay according to claim 1 and wherein said fixing the wire antenna comprises:
removably mounting said substrate onto a movable surface; and
moving said substrate relative to a fixed wire embedding device for fixing said wire antenna to said substrate.

13. A method for manufacturing a smart card inlay comprising:
removably mounting a substrate onto a movable surface; and
moving said substrate relative to a fixed wire embedding device for fixing a wire antenna to said substrate.

14. A smart card inlay comprising:
a substrate; and
a wire antenna fixed to the substrate and having first and second ends thereof connected to a chip module mounted in an aperture formed in said substrate, wherein said first and second ends do not extend from said antenna past said chip module.

15. A smart card inlay according to claim 14 and wherein said wire antenna is not fixed to the substrate in the vicinity of said aperture.

16. A system for manufacturing a smart card inlay comprising:
an electrical connecting tool operative to initially connect a first end of a wire antenna to a chip module mounted in an aperture on a substrate;
a wire antenna placement tool operative to thereafter fix the wire antenna onto said substrate; and
an electrical connecting tool operative to thereafter connect a second end of the wire antenna to the chip module.

17. A system for manufacturing a smart card inlay comprising:
a wire antenna producing and connecting tool operative to provide a wire antenna having a first end and a second end arranged such that said first end and said second end are connected to a chip module and do not extend past said chip module; and
a wire antenna mounting tool operative to fix said wire antenna to a substrate.

18. A system for manufacturing a smart card inlay comprising:
a wire antenna placement tool operative to fix a wire antenna, having a first end and a second end, to a substrate, aside from said first end and said second end;
a wire relocation tool operative to thereafter relocate said first end and said second end of said wire antenna to locations suitable for attachment to a chip module;
and an electrical connecting tool operative to thereafter connect said first end and said second end to said chip module.

19. A system for manufacturing a smart card inlay comprising:
an electrical connecting tool operative to connect a first end and a second end of a wire antenna to a chip module;
a wire antenna placement tool operative to fix said wire antenna to a substrate; and
a chip module relocation tool operative to thereafter relocate said chip module to a chip module location on said substrate.

20. A system for manufacturing a smart card inlay according to claim 19 and said electrical connecting tool is operative to:
connect said first end prior to said wire antenna placement tool fixing said wire antenna to a substrate; and
connect said second end subsequent to said wire antenna placement tool said fixing said wire antenna to a substrate.

21. A system for manufacturing a smart card inlay comprising:
a wire attaching tool operative to attach first and second ends of a wire antenna to a first substrate;
a wire antenna placement tool operative to fix said wire antenna, aside from said first and second ends thereof, to a second substrate;
a substrate relocating tool operative to thereafter relocate said first substrate relative to said second substrate such that said first and second ends of said wire antenna are at locations suitable for connection to a chip module on said second substrate;
an electrical connecting tool operative to thereafter connect said first end and said second end to said chip module; and
a substrate removing tool operative to thereafter remove said first substrate.

22. A system for manufacturing a smart card inlay according to claim 21 and wherein said wire attaching tool is operative to:
connect said first end prior to said wire antenna placement tool fixing said wire antenna to a substrate; and
connect said second end subsequent to said wire antenna placement tool said fixing said wire antenna to a substrate.

23. A system for manufacturing a smart card inlay comprising:
a holding device operative to hold a first end of a wire antenna;
a wire antenna placement tool operative to thereafter fix said wire antenna onto a substrate;
a wire placement tool operative thereafter to place a second end of said wire antenna into said holding device; and
an electrical connecting tool operative to thereafter connect said first end and said second end to a chip module.

24. A system for manufacturing a smart card inlay comprising:
a first holding device operative to initially hold a first end of a wire antenna;
a wire antenna placement tool operative to thereafter fix said wire antenna onto a substrate;
a second holding device operative to thereafter hold a second end of said wire antenna; and
an electrical connecting tool operative to thereafter connect said first end and said second end to a chip module.

25. A system for manufacturing a smart card inlay according to claim 23 and also comprising a chip module attaching tool operative to attach said chip module to said substrate.

26. (canceled)

27. A system for manufacturing a smart card inlay according to claim 16 and wherein said wire antenna placement tool comprises:
a fixed wire embedding device operative to fix said wire antenna to said substrate; and
a movable surface operative to move said substrate relative to said fixed wire embedding device.

28. A system for manufacturing a smart card inlay comprising:
a fixed wire embedding device operative to fix a wire antenna to a substrate; and
a movable surface operative to move said substrate relative to said fixed wire embedding device.
